(19) United States
(12) Patent Application Publication
(10) Pub. No.: US 2010/0052931 A1
(43) Pub. Date: Mar. 4, 2010

(54) GESTURE CONTROL KEY FOB

(75) Inventors: Kevin G. Kolpasky, Oakland Township, MI (US); David T. Proefke, Madison Heights, MI (US); Ryan O'Keefe, Clawson, MI (US); Janet S. Goings, Commerce Township, MI (US); Louise E. Stauffer, Bloomfield Hills, MI (US); Nancy S. Martinelli, Grosse Ile, MI (US); Kate Marie Schreiber, Cambridge, MA (US); Dirk Ahlgrim, Cambridge, MA (US); Gian Antonio Pangaro, Boston, MA (US); Robert Francis Hartmann, Westford, MA (US); Gaius S. Lim, Ann Arbor, MI (US); Clark E. McCall, Ann Arbor, MI (US)

Correspondence Address: MILLER IP GROUP, PLC;GENERAL MOTORS CORPORATION, 42690 WOODWARD AVENUE, SUITE 200, BLOOMFIELD HILLS, MI, 48304, US

(73) Assignee: GM GLOBAL TECHNOLOGY OPERATIONS, INC., Detroit, MI (US)

(21) Appl. No.: 12/198,423

(22) Filed: Aug. 26, 2008

(51) Int. Cl. G08B 21/00

(52) U.S. Cl. 340/670

(57) ABSTRACT

A key fob for a vehicle that provides a certain vehicle function depending on the motion applied to the key fob. The key fob includes a switch that is pressed when the vehicle operator wishes to transmit a command. Pressing the switch causes a device, such as a camera or accelerometer, to be put in a motion detecting mode, where a subsequent motion of the key fob causes the key fob to transmit a command associated with that motion. For example, the vehicle operator can press the switch on the key fob and make an upward motion, which will cause the vehicle door locks to unlock. Likewise, pressing the switch on the key fob and making a downward motion may cause the door locks to lock.

### BACKGROUND OF THE INVENTION

1. Field of the Invention

This invention relates generally to a key fob for a vehicle and, more particularly, to a key fob for a vehicle that transmits a particular command to the vehicle depending on the motion applied to the key fob.

2. Discussion of the Related Art

Modern vehicles typically include a key fob that wirelessly transmits RF command signals to a vehicle controller to perform a certain vehicle function, such as lock the doors, unlock the doors, open the trunk, open the hatch, start the engine, etc. The vehicle operator will press a particular push button on the key fob that typically has an image of the function that the button provides in order to transmit the command to the vehicle. The transmission is coded in such a manner that not only does the command perform a certain operation, but also protects the transmission from being recorded and resent by a third party. Key fobs of this type typically have a limited range, and provide a convenience factor for the vehicle operator.

Nintendo offers a product referred to as WiiWare that is an interactive device for video games and other interactive systems. WiiWare uses a transmission device that the user moves in a particular direction to cause a video image on a monitor to move in the same manner that the device is moved. For example, a Wii transmission device can be a steering wheel and the video image can be a race car, where the steering wheel is used to turn the car in the direction desired. The Wii transmission device includes an accelerometer that detects the direction and speed of motion of the device that is transmitted to a controller associated with the device. The controller then sends an appropriate signal that causes images in the video to move in a programmed manner.

### SUMMARY OF THE INVENTION

In accordance with the teachings of the present invention, a key fob for a vehicle is disclosed that provides a certain vehicle function depending on the motion applied to the key fob. The key fob includes a switch that is pressed when the vehicle operator wishes to transmit a command. Pressing the switch causes a device, such as a camera or accelerometer, to be put in a motion detecting mode, where a subsequent motion of the key fob causes the key fob to transmit a command associated with that motion. For example, the vehicle operator can press the switch on the key fob and make an upward motion, which may cause the vehicle door locks to unlock. Likewise, pressing the switch on the key fob and making a downward motion may cause the door locks to lock.

Additional features of the present invention will become apparent from the following description and appended claims, taken in conjunction with the accompanying drawings.

### BRIEF DESCRIPTION OF THE DRAWINGS

FIG. 1 is a perspective view of a key fob that transmits a command based on the motion applied to the fob, according to an embodiment of the present invention;

FIG. 2 is a top view of the key fob shown in FIG. 1;

FIG. 3 is a bottom view of the key fob shown in FIG. 1;

FIG. 4 is a simplified block diagram of circuitry within the key fob shown in FIG. 1;

FIG. 5 is an illustration of a vehicle operator making an upward motion to the key fob to unlock the vehicle doors;

FIG. 6 is an illustration of the vehicle operator making a downward motion to the key fob to lock the vehicle doors;

FIG. 7 is an illustration of a vehicle operator wiggling the key fob to wake up a controller on the vehicle;

FIG. 8 is an illustration of a vehicle operator rotating the key fob to send a command to start the vehicle engine;

FIG. 9 is an illustration of the vehicle operator making a sweeping motion with the key fob to the left and right to send a command to locate the vehicle; and

FIG. 10 is a broken-away perspective view of the key fob shown in FIG. 1 with a valet portion removed.

### DETAILED DESCRIPTION OF THE EMBODIMENTS

The following discussion of the embodiments of the invention directed to a key fob that transmits a command signal based on a motion applied to the key fob is merely exemplary in nature, and is in no way intended to limit the invention or its applications or uses. For example, although the discussion below specifically concerns a key fob for a vehicle, other devices can be based on the principals described herein, such as PDAs or cell phones.

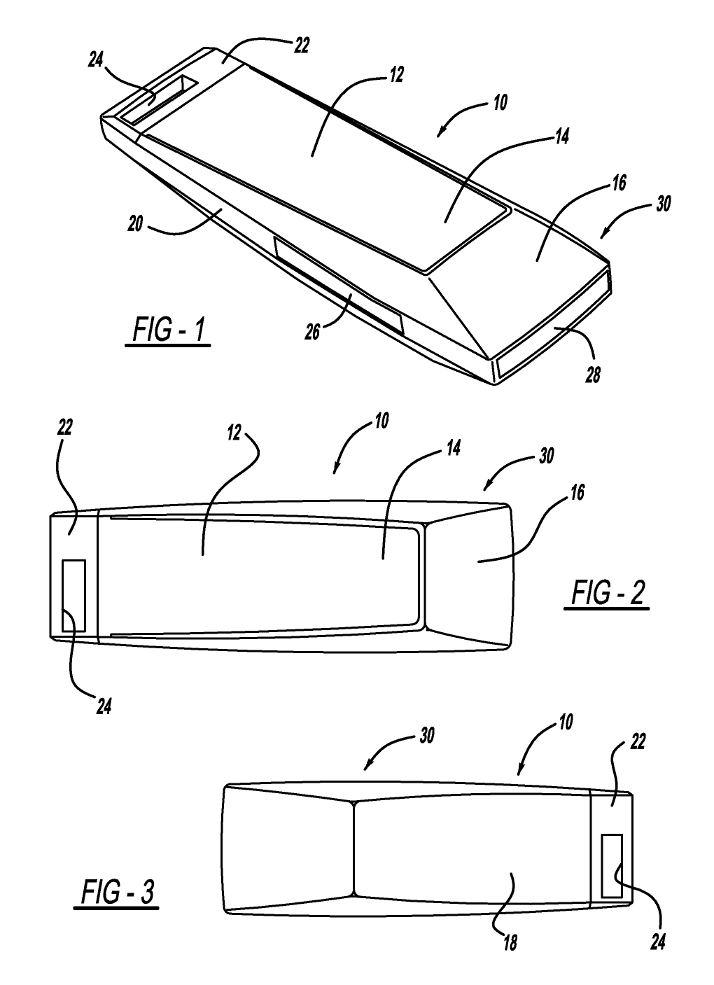

FIG. 1 is a perspective view, FIG. 2 is a front view and FIG. 3 is a back view of a key fob 10, according to an embodiment of the present invention. In one non-limiting embodiment, the key fob 10 is about three inches long, one inch wide and ⅔ of an inch deep. As will be discussed below, the key fob 10 transmits a command signal to a vehicle to perform a particular operation, such as the known key fob operations, for example, locking the vehicle doors, unlocking vehicle doors, unlocking the trunk, remote start, etc. The key fob 10 provides these commands not by activating an independent switch for each command, but by providing a particular motion to the key fob 10 that is detected by a suitable motion detecting device, which causes a controller to transmit the command depending on the motion. The technology to wirelessly transmit commands based on the motion of a device is known in the art, such as that discussed above for the WiiWare technology.

The key fob 10 has an outer housing 30 including a front panel 12 having an integral activation button 14 that activates the key fob 10 to transmit the command. Particularly, the activation button 14 is pressed to put the key fob 10 in a motion detecting mode where the key fob 10 will now respond to a motion of the key fob 10. In one embodiment, the activation button 14 is held during the motion of the fob 10. However, this is not a requirement in that the button 14 can be pressed and released to put the key fob 10 in the motion detecting mode. The key fob 10 also includes a display 16 on the front panel 12 that provides a visual indication of the command that is activated by the motion of the key fob 10. The key fob housing 30 also includes a back panel 18 having a general triangular curvature providing an aesthetically pleasing shape. Further, the shape of the back panel 18 provides a comfortable shape for the user's hand when pressing the button 14 with the user's thumb. The key fob housing 30 also includes a side panel 20 extending around the key fob 10 between the top plate 12 and the bottom plate 18, as shown. A base portion 22 provides a rigid support for the front panel 12, the back panel 18 and the side panel 20, and includes a slot 24 for accepting a key ring.

As mentioned above, the key fob 10 transmits a command based on the motion applied to the key fob 10 after the button 14 is pressed to put the key fob 10 in the motion detecting mode. Additionally, switches can be provided on the key fob 10 for some of the major command actuations where using the motion of the fob 10 may not desirable. In this regard, a toggle switch 26 is provided in the side panel 20 where one end of the toggle switch 26 can be pressed to lock the vehicle doors and an opposite end of the toggle switch 26 can be pressed to unlock the vehicle doors. Additionally, a switch 28 can be provided in the side panel 20 at the front of the key fob 10, as shown, that activates the vehicle horn to provide an alarm or a vehicle finder.

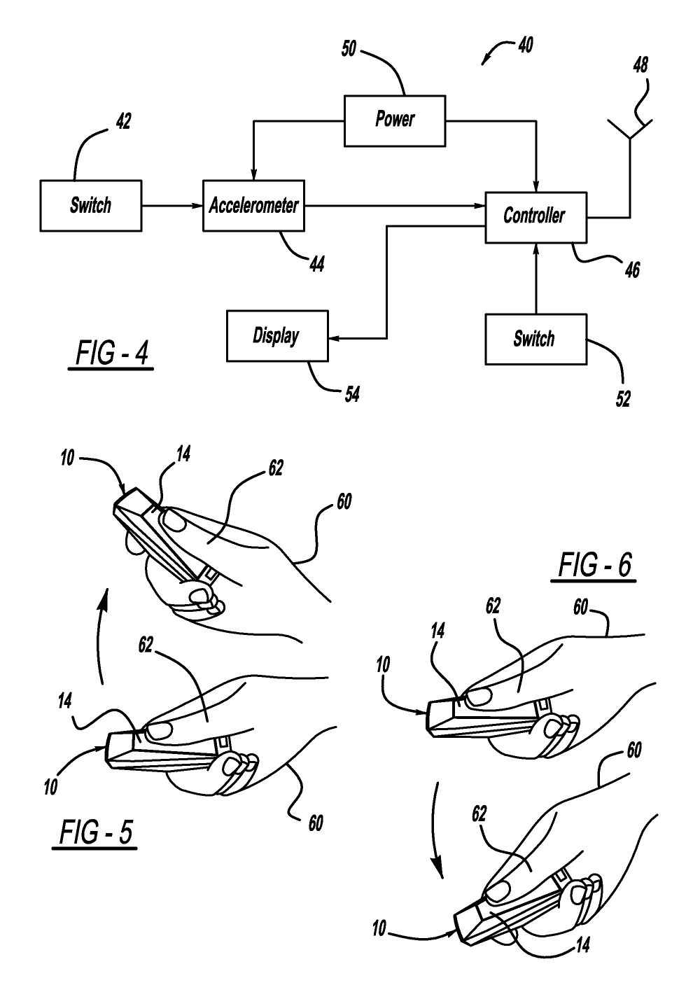

FIG. 4 is a simplified block diagram of a circuit 40 that can be provided within the key fob 10. The circuit 40 includes a switch 42 that represents the button 14, and when pressed, sends a signal to an accelerometer 44 that operates as the motion detecting device. The accelerometer 44 can be any accelerometer suitable for the purposes described herein that is small enough to fit within the housing 30 of the key fob 10 and detect the various motions of the key fob 10, as will be further discussed below. Once the accelerometer 44 receives the signal form the switch 42, it will provide a zeroing calibration to the current location of the key fob 10. When the key fob 10 is then subsequently moved in a particular direction, the accelerometer 44 provides a signal to a controller 46 indicating the speed and direction of the motion of the key fob 10. The controller 46 is programmed to transmit a particular command by an antenna 48 depending on the motion identified by the accelerometer 44. Thus, the vehicle operator can activate the switch 42 and provide a predetermined motion to the key fob 10, which will be deciphered by the controller 46 to transmit the command associated with that motion.

The embodiment discussed above for the key fob 10 employs the accelerometer 44 for detecting the motion of the fob 10. However, this is merely one example of a suitable device for detecting motion. In an alternate embodiment, the accelerometer 44 can be a camera where the motion of the fob 10 is detected by images provided by the camera. Also, instead of detecting the motion of the fob 10 by a device on the fob 10, another embodiment may detect the motion of the fob 10 remotely from the fob 10, such as by a camera mounted on the vehicle. Alternatively, the key fob 10 can employ both a camera and an accelerometer to provide combined detection of the motion of the fob 10. Further, the discussion above states that the controller 46 interprets the motion of the key fob 10. In an alternate embodiment, signals from the accelerometer 44 identifying the motion can be transmitted to a remote device on the vehicle or another customer carried device where the motion is interpreted.

The system 40 includes a battery 50 that provides power to the accelerometer 44 and the controller 46, as well as other devices and components within the key fob 10. A switch 52 represents the other switches on the key fob 10, such as the switches 26 and 28, where a direct command is given to the controller 46 to transmit a particular command. The command identified either from the accelerometer 44 or the switch 52 is displayed on a display 54.

FIGS. 5-9 show a hand 60 of a vehicle operator where a thumb 62 is pressing the button 14 and the hand 60 is making a particular motion while the button 14 is pressed to provide a particular command. It is stressed that these motions are merely representative where any motion detectable by the accelerometer 44 can be used to provide a particular vehicle function for a particular vehicle design.

FIG. 5 shows the thumb 62 pressing the button 14 and the hand 60 making an upward motion to the key fob 10 to unlock the driver's door of the vehicle. A double press of the button 14 and an upward motion of the key fob 10 can be used to unlock all of the doors of the vehicle.

FIG. 6 is an illustration of the thumb 62 pressing the button 14 and the hand 60 making a downward motion to lock the doors of the vehicle.

FIG. 7 is an illustration of the thumb 62 pressing the button 14 and the hand 60 wiggling the key fob 10 sideways to wake up the vehicle or controller.

FIG. 8 is an illustration of the thumb 62 pressing the button 14 and the hand 60 rotating the key fob 10 in a particular direction, here clockwise, to provide a remote start of the vehicle engine.

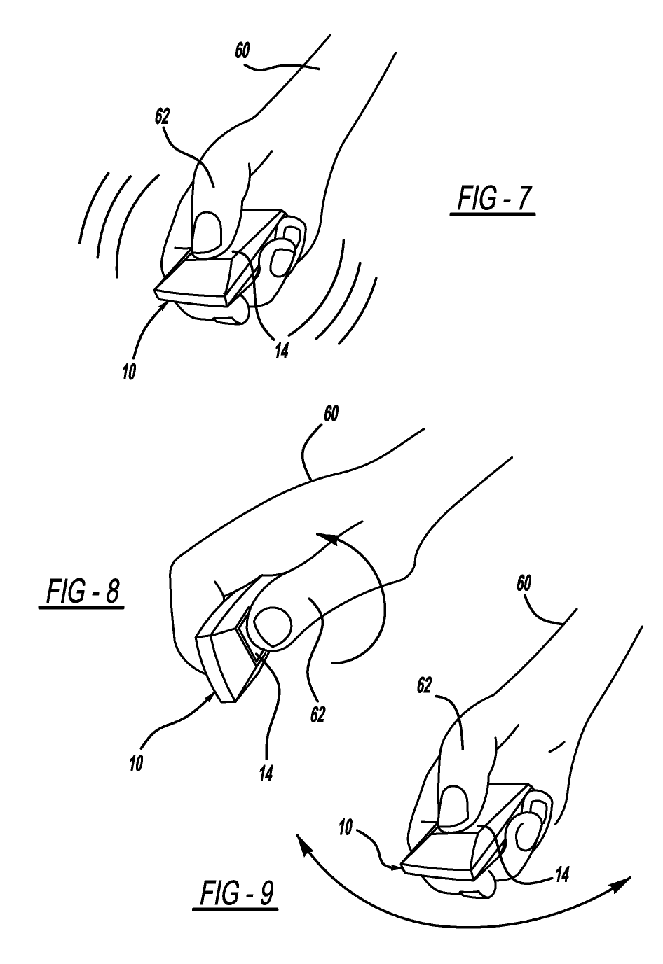

FIG. 9 is an illustration of the thumb 62 pressing the button 14 and the hand 60 sweeping the key fob 10 left and right to activate the vehicle horn as a vehicle finder.

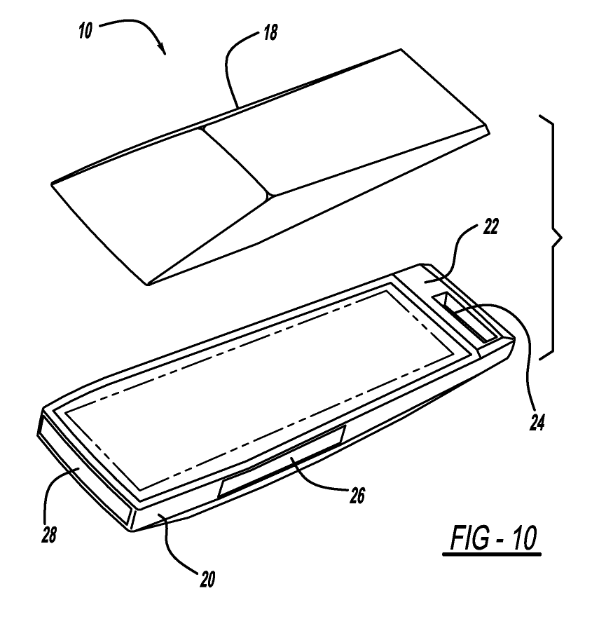

FIG. 10 is an illustration of the key fob 10 where the back panel 18 has been removed and includes suitable circuitry for a valet to gain access to the vehicle.

By employing a single button for the multiple operations of the key fob 10, the size of the key fob 10 can remain the same and other functions can be programmed into the controller 46, whereas otherwise, the size and configuration of the key fob would need to change because additional buttons have been added. In other words, because a single switch is used to activate several commands, the key fob 10 can be programmed to add additional functions based on different motions of the key fob 10 without changing the physical structure of the key fob 10.

The foregoing discussion discloses and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. A unit for providing a command to a vehicle, said unit comprising:
a housing;
a detecting mode switch provided in the housing;
a motion detecting device responsive to a detecting signal from the detecting mode switch that puts the motion detecting device in a detecting mode, said motion detecting device detecting a motion of the unit while it is in the detecting mode; and
a controller responsive to a motion signal from the motion detecting device identifying the motion of the unit, said controller causing a predetermined command signal to be transmitted based on the motion of the unit that performs a predetermined function on the vehicle.

2. The unit according to claim 1 wherein the motion detecting device is an accelerometer.

3. The unit according to claim 1 wherein the motion detecting device is a camera.

4. The unit according to claim 1 wherein an upward motion of the unit identified by the motion detecting device causes the controller to send a command signal to unlock the vehicle doors.

5. The unit according to claim 1 wherein a downward motion of the unit identified by the motion detecting device causes the controller to send a command signal to lock the vehicle doors.

6. The unit according to claim 1 wherein a rotating motion of the unit identified by the motion detecting device causes the controller to send a command signal to start the vehicle.

7. The unit according to claim 1 wherein a sweeping motion of the unit identified by the motion detecting device causes the controller to send a command signal to identify the vehicle.

8. The unit according to claim 1 further comprising a door lock switch and a door unlock switch on the housing.

9. The unit according to claim 8 wherein the unlock switch and the lock switch are in a side panel of the housing of the key fob.

10. The unit according to claim 1 wherein the housing is more than three times as long as it is wide.

11. The unit according to claim 1 further comprising a display that displays an image identifying the command signal sent by the controller.

12. The unit according to claim 1 wherein the housing includes a removable back panel for a valet.

13. A key fob for a vehicle comprising:
a key fob housing;
an accelerometer switch provided in the key fob housing;
an accelerometer responsive to an accelerometer switch signal from the accelerometer switch, said accelerometer detecting a motion of the key fob; and
a controller responsive to an accelerometer control signal from the accelerometer identifying the motion of the key fob, said controller causing a predetermined command signal to be transmitted based on the motion of the key fob that performs a predetermined vehicle function, where the controller provides a command for an upward motion, a downward motion, a rotating motion and a sweeping motion.

14. The key fob according to claim 13 wherein the upward motion of the key fob causes the controller to send a command signal to unlock the vehicle doors, the downward motion of the key fob causes the controller to send a command signal to lock the vehicle doors, the rotating motion of the key fob causes the controller to send a command signal to start the vehicle, and the sweeping motion of the key fob causes the controller to send a command signal to identify the vehicle.

15. The key fob according to claim 13 wherein the only switch on the housing is the accelerometer switch.

16. The key fob according to claim 13 further comprising a door lock switch and a door unlock switch on the housing.

17. The key fob according to claim 16 wherein the unlock switch and the lock switch are in a side panel of the housing of the key fob.

18. The key fob according to claim 13 wherein the housing is more than three times as long as it is wide.

19. The key fob according to claim 13 further comprising a display that displays an image identifying the command signal sent by the controller.

20. A key fob for a vehicle comprising circuitry responsive to an actuation signal, said circuitry wirelessly transmitting a command to the vehicle to perform a vehicle function in response to the actuation signal and a subsequent motion of the key fob.
